(19) United States
(12) Patent Application Publication
(10) Pub. No.: US 2006/0219650 A1
(43) Pub. Date: Oct. 5, 2006

(54) Telescopic boom device

(75) Inventor: Osamu Gokita, Niihari-gun (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI CONSTRUCTION MACHINERY CO., LTD., TOKYO (JP)

(21) Appl. No.: 10/548,325

(22) PCT Filed: Mar. 8, 2004
(86) PCT No.: PCT/JP04/02939

§ 371 Date: Jun. 9, 2006

(30) Foreign Application Priority Data
Mar. 7, 2003 (JP) 2003-61791

(51) Int. Cl. B66C 23/42

(52) U.S. Cl. 212/350

(57) ABSTRACT

A telescopic boom device is constructed of a first boom section 1, a second boom section 2 telescopically received in the first boom section 1, and an extension/retraction cylinder. The boom sections 1,2 are constructed of main parts 1a,2a, boss brackets 1c,2c arranged integrally on ends of the main parts 1a,2a via partitions 1b,2b, slide pad brackets 1e,2e arranged integrally on opposite ends of the main parts 1a,2a via partitions 1d,2d, respectively, bosses 1f,2f arranged on the boss brackets 1c,2c, and slide pads 1g,2g arranged on the slide pad brackets 1e,2e, respectively. The plural slide pads 1g are attached on an inner wall of the slide pad bracket 1e formed larger in the width dimension and height dimension than the main part 1a, and the plural slide pads 2g are attached on an outer wall of the slide pad bracket 2e formed smaller in the width dimension and height dimension than the main part 2a. The telescopic boom device can avoid increases in the dimensions of the cross-sectional contour despite the arrangement of the slide pads 1g, 2g.

### TECHNICAL FIELD

This invention relates to a telescopic boom device suitable for arrangement, for example, on a hydraulic working machine such as a lift truck or a high-lift work platform vehicle, and especially to the construction of individual boom section in the telescopic boom device.

### BACKGROUND ART

Conventionally, a hydraulic working machine such as a lift truck or a high-lift work platform vehicle is equipped with a telescopic boom device which can be telescopically extended or retracted by extending or retracting an extension/retraction cylinder.

FIG. 12 is a cross-sectional view showing one example of conventionally-known telescopic boom devices of this type. As clearly envisaged from this figure, the telescopic boom device according to the conventional art is constructed of a straight tubular, base boom section 21a left open at an end, a straight tubular, intermediate boom section 21b telescopically inserted in the base boom section 21a, a straight tubular, fly boom section 21c telescopically inserted in the intermediate boom section 21b, an extension/retraction cylinder 22 arranged between the base boom section 21a and the intermediate boom section 21b to extendingly or retractingly operate the intermediate boom section 21b relative to the base boom section 21a, and a wire-sheave mechanism for extendingly or retractingly operating the fry boom section 21c relative to the intermediate boom section 21b in association with an extension or retraction of the extension/retraction cylinder 22 (see, for example, FIG. 2 of JP-A-05-082986 [U]).

The telescopic boom device of the above-described construction can extend a boom main body 21, which is composed of the base boom section 21a, intermediate boom section 21b and fry boom section 21c, by actuating the extension/retraction cylinder 22 in an extending direction, and can also retract the boom main body 21 by actuating the extension/retraction cylinder 22 in a retracting direction.

### DISCLOSURE OF THE INVENTION

To smoothen the operation of the boom main body 21 and also to achieve improvements in the durability of the boom main body 21 and the prevention of production of abnormal sounds from the boom main body, slide pads made, for example, of a resin material of excellent slidability are arranged as slide members between the respective boom sections 21a, 21b, 21c in the telescopic boom device of the above-described construction. As the respective boom sections 21a, 21b, 21c are formed as straight rectangular tubes in the telescopic boom device according to the conventionally-known art, the arrangement of the slide pads on the inner or outer walls of the respective boom sections 21a, 21b, 21c requires spaces between the respective boom sections 21a,21b,21c for the arrangement of the slide pads. If one wants to maintain the cross-sectional shape along line J-J (hereinafter simply called “the cross-sectional shape”) of the fry boom section 21c shown in FIG. 12, the cross-sectional shapes of the intermediate boom section 21b and base boom section 21a have to be made larger by as much as the thickness of the slide pads because of the arrangement of the slide pads between the respective boom sections. This results in an enlargement of the boom main body. In an extreme case, it may become difficult to lay out the boom main body 21 on the vehicle body. If one wants to maintain the cross-sectional shape of the base boom section 21a, in contrast, the cross-sectional shapes of the intermediate boom section 21b and fry boom section 21c have to be made smaller by as much as the thickness of the slide pads. This leads to a reduction in the strength of these boom sections 21b, 21c.

The present invention has been completed to resolve such inconvenience of the conventional art, and therefore, its object is to provide a telescopic boom device which permits the arrangement of slide contact members without resulting in an enlargement of the cross-sectional contour dimensions.

To achieve the above-described object, the first aspect of the present invention is characterized in that in a telescopic boom device having a group of tubes comprising an outer tube and at least one inner tube arranged in the outer tube such that the at least one inner tube is slidable relative to the outer tube, an extension/retraction drive mechanism for extending or retracting the outer tube and the at least one inner tube relative to each other, and slide members arranged within a space formed adjacent the outer tube and the at least one inner tube to smoothen relative sliding movements between the adjacent tubes, a first bracket for mounting there on slide members, which undergo sliding contact with an outer wall of the adjacent inner tube, is arranged on an inner wall of the outer tube with a clearance from an outer wall of the inner cylinder; and a second bracket for mounting thereon slide members, which undergo sliding contact with the inner wall of the outer tube, is arranged on the outer wall of the inner tube, which is located adjacent the outer tube, with a clearance from the inner wall of the outer tube.

In the telescopic boom device, the first bracket may be arranged on a side of an end portion of the outer tube, and the second bracket may be arranged on a side of an end portion of the inner tube. The latter end portion is located on a side opposite to the first bracket.

A third bracket for mounting thereon slide members, which undergo sliding contact with the inner wall of the inner tube, may be arranged on a side of an outer wall of a second inner tube, said outer wall being located adjacent the inner wall of the inner tube, with a clearance from the inner wall of the inner tube, and a fourth bracket for mounting thereon slide members, which undergo sliding contact with the outer wall of the second inner tube, may be arranged on a side of the inner wall of the inner tube, said inner wall being located adjacent the outer wall of the second inner tube, with a clearance from the outer wall of the second inner tube. In this case, the first bracket may be arranged on a side of an end portion of the outer tube, the second bracket may be arranged on a side of an end portion of the innertube, said end portion being located on a side opposite to the first bracket, the third bracket may be arranged on a side of an end portion of the second inner tube, said end portion being located on a side of the second bracket, and the fourth bracket may be arranged on a side of an end portion of the inner tube, said end portion being located on a side of the first bracket. Further, each bracket can be arranged at a location not interfering with sliding movements of its associated tubes.

Furthermore, the first bracket and second bracket may be provided at end portions thereof with connection parts which are connected to a drive end of the extension/retraction drive mechanism. The connection parts can be secured by welding to the end portions of the first and second brackets.

The second aspect of the present invention is characterized in that in a telescopic boom device having at least two boom sections and an extension/retraction cylinder for telescopically extending or retracting the at least two boom sections, the at least two boom sections are each constructed of a straight tubular, main part having strength and a slide pad bracket having a length shorter or longer than a length of a cross-sectional contour of the main part; the slide pad bracket the length of which is shorter than the length of the cross-sectional contour of the main part is provided on an outer wall thereof with slide pads; and the slide pad bracket the length of which is longer than the length of the cross-sectional contour of the main part is provided on an inner wall thereof with slide pads.

In the above-described telescopic boom device according to the second aspect of the present invention, a first boom section and a second boom section telescopically inserted in the first boom section may be provided as the booms; a slide pad bracket having a length longer than the length of the cross-sectional contour of the main part may be arranged on a free end portion of the first boom section, and the slide pads may be mounted on an inner wall of the slide pad bracket; and a slide pad bracket having a length shorter than the length of the cross-sectional contour of the main part may be arranged on a side of a basal end of the second boom section, and the slide pads may be mounted on an outer wall of the slide pad bracket.

Further, a first boom section, at least one second boom section telescopically inserted in the first boom section and a third boom section telescopically inserted in the second boom section may be provided as the booms; a slide pad bracket having a length longer than the length of the cross-sectional contour of the main part may be arranged on a free end portion of the first boom section, and the slide pads may be mounted on an inner wall of the slide pad bracket; a slide pad bracket having a length longer than the length of the cross-sectional contour of the main part may be arranged on a free end portion of the second boom section, a slide pad bracket having a length shorter than the length of the cross-sectional contour of the main part may be arranged on a basal end portion of the second boom section, and the slide pads may be mounted on an inner wall of the slide pad bracket the length of which is longer than the length of the cross-sectional contour of the main part and on an outer wall of the slide pad bracket the length of which is shorter than the length of the cross-sectional contour of the main part; and a slide pad bracket having a length shorter than the length of the cross-sectional contour of the main part may be arranged on a basal end portion of the third boom section, and the slide pads may be mounted on an outer wall of the third boom section.

In the above-described second aspect, in the at least two boom sections, the two boom sections which are provided with the extension/retraction cylinder may each be constructed of a straight tubular, main part, a slide pat bracket having a length shorter or longer than a length of a cross-sectional contour of the main part, and a boss bracket welded to the main part; and bosses for connecting the extension/retraction cylinder may be arranged on an inner wall of the boss bracket.

By constructing as described above, it is possible to provide a telescopic boom device which permits the arrangement of slide members without resulting in enlargements of the cross-sectional contour dimensions.

In the following embodiments, the outer tube corresponds to a first boom section 1, the inner tube to the second boom section 2, the slide members to slide pads 1g, 2g, 3g, the space to slide pad brackets 1e, 2e, 2e₁, 2e₂, 3e, the first bracket to 1e, the second bracket to slide pad brackets 2e, 2e₂, the fourth bracket to a slide pad bracket 2e₁, and the connection part to boss brackets 1c, 2c, respectively.

### BRIEF DESCRIPTION OF THE DRAWINGS

FIG. 1 is a partly cut-off, side view of a telescopic boom device according to a first embodiment.

FIG. 2 is an end cross-sectional view taken along a plane A in FIG. 1.

FIG. 3 is an end cross-sectional view taken along a plane B in FIG. 1.

FIG. 4 is an end cross-sectional view taken along a plane C in FIG. 1.

FIG. 5 is an end cross-sectional view taken along a plane D in FIG. 1.

FIG. 6 is an end cross-sectional view taken along a plane E in FIG. 1.

FIG. 7 is an end cross-sectional view taken along a plane F in FIG. 1.

FIG. 8 is an end cross-sectional view taken along a plane G in FIG. 1.

FIG. 9 is an end cross-sectional view taken along a plane H in FIG. 1.

FIG. 10 is an end cross-sectional view taken along a plane I in FIG. 1.

FIG. 11 is a cross-sectional view schematically illustrating the construction of a telescopic boom device according to a second embodiment.

FIG. 12 is a cross-sectional view depicting one example of telescopic boom devices according to the conventional art.

### BEST MODES FOR CARRYING OUT THE INVENTION

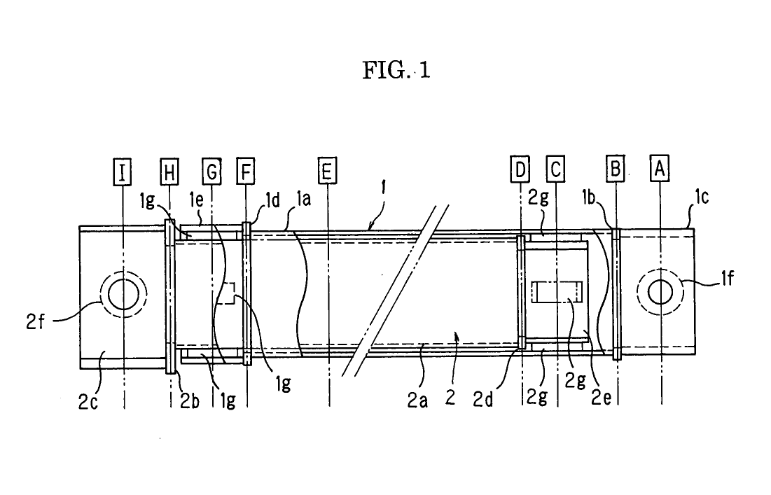

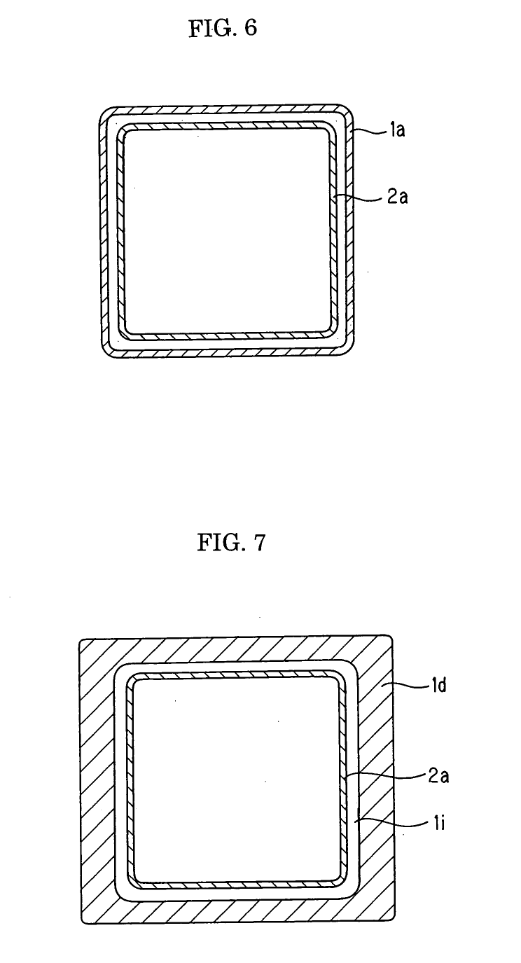

With reference to FIG. 1 through FIG. 10, a description will hereinafter be made about the telescopic boom device according to the first embodiment of the present invention.

As apparent from FIG. 1, the telescopic boom device of this embodiment is constructed of a first boom section, a second boom section telescopically received in the first boom section, and an unillustrated extension/retraction cylinder.

The first boom section 1 is composed of a main part 1a formed in the shape of a straight, bottomless, rectangular tube, a boss bracket 1c arranged integrally on an end of the main part 1a via a partition 1b, a slide pad bracket 1e arranged integrally on an opposite end of the main part 1a via a partition 1d, bosses 1f arranged on the boss bracket 1c, and slide pads 1g arranged on the slide pad bracket 1e.

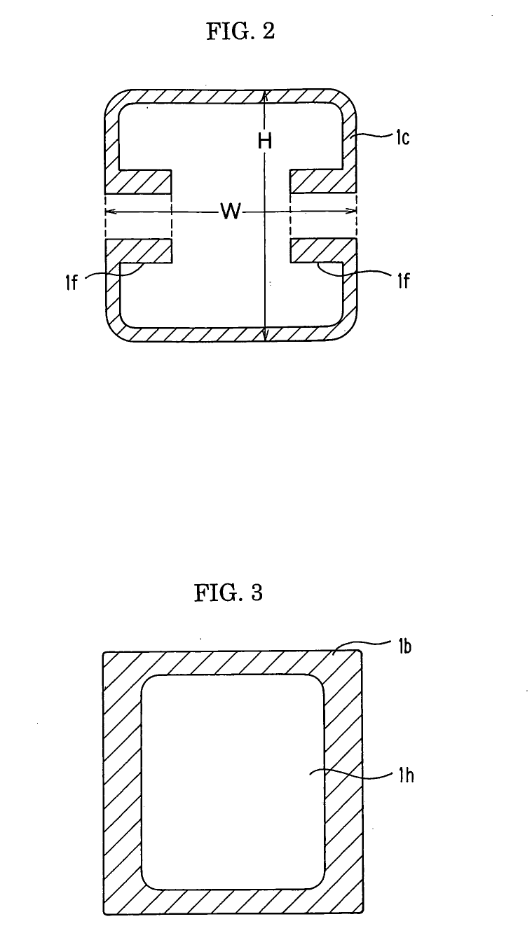

As illustrated in the side view of FIG. 1 and the end cross-sectional view of FIG. 2, the boss bracket 1c is formed in the shape of a bottomless rectangular tube having a cross-sectional shape the width dimension W and height dimension H of which are substantially the same as the width dimension and height dimension of the main part 1a, and the overall length of the boss bracket is significantly shorter than the overall length of the main part 1a and is set at a length approximately several times as large as the diameter of each boss 1f, in other words, at a length sufficient only to arrange the bosses 1f. On an inner wall of the boss bracket 1c, the two bosses 1f are arranged opposite to each other, and the bosses are secured to the boss bracket 1c by welding.

The partition 1b is formed in the shape of a plate, and as depicted in FIG. 1 and FIG. 3, is centrally provided with a rectangular hollow interior 1h. The width dimension and height dimension of its contour are slightly greater than the width dimension and height dimension of the main part 1a, and its inner width dimension and height dimension are formed substantially equal to the inner width dimension and height dimension of the main part 1a.

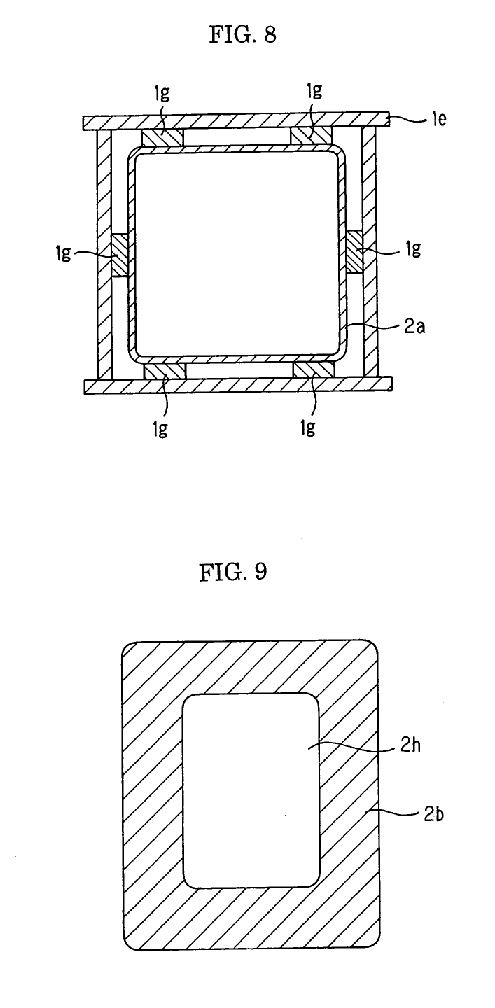

As illustrated in FIG. 1 and FIG. 8, the slide pad bracket 1e is formed in the shape of a straight, bottomless, rectangular tube having an inner width dimension and height dimension greater than the width dimension and height dimension of the main part 1a, and its overall length is formed shorter than the overall length of the main part 1a and at such a length as permitting the mounting of the slide pads 1g. On the inner wall of the slide pad bracket 1e, plural (6 in the embodiment of FIG. 8) slide pads 1g are mounted at substantially equal intervals in the direction of an outer circumference of the slide pad bracket. The slide pads 1g are formed in the shape of blocks, for example, with a resin material having excellent slidability such as polytetrafluoroethylene. These slide pads 1g are fixedly secured by screws, an adhesive or the like on the inner wall of the slide pad bracket 1e to smoothen relative sliding movements between the first boom section 1 and the second boom section 2. It is to be noted that the slide pad bracket 1e is shorter in the longitudinal dimension than the main part 1a and is formed of four plates.

The partition 1d is formed in the shape of a plate, and as depicted in FIG. 1 and FIG. 7, is centrally provided with a rectangular hollow interior 1i. The width dimension and height dimension of its contour are greater than the width dimension and height dimension of the main part 1a, and its inner width dimension and height dimension are formed substantially equal to the inner width dimension and height dimension of the main part 1a.

The boss bracket 1c and slide pad bracket 1e are integrated by welding with the main part 1a such that they become coaxial with each other via the partitions 1b, 1d. The partitions 1b, 1d are used to reduce the man-hour upon integrally securing the boss bracket 1c and slide pad bracket 1e to the main part 1a, all of which are different in cross-sectional shape.

The second boom section 2 is composed of a main part 2a formed in the shape of a straight, bottomless, rectangular tube having such a contour as permitting the insertion of the second boom section 2 in the main part 1a of the first boom section 1, a boss bracket 2c arranged integrally on an end of the main part 2a via a partition 2b, a slide pad bracket 2e arranged integrally on an opposite end of the main part 2a via a partition 2d, bosses 2f arranged on the boss bracket 2c, and slide pads 2g arranged on the slide pad bracket 2e.

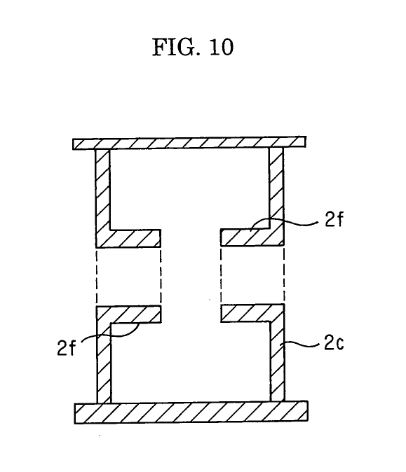

As illustrated in FIG. 1 and FIG. 10, the boss bracket 2c is formed in the shape of a bottomless rectangular tube having substantially the same width dimension and height dimension as the slide pad bracket 1e in the first boom section 1, and the overall length of the boss bracket is significantly shorter than the overall length of the main part 2a and is formed approximately several times as large as the diameter of each boss 2f, in other words, at a length sufficient only to arrange the bosses 2f. On an inner wall of the boss bracket 2c, the two bosses 2f are arranged opposite to each other, and the bosses are secured to the boss bracket 2c by welding.

The partition 2b is formed in the shape of a plate, and as depicted in FIG. 1 and FIG. 9, is centrally provided with a rectangular hollow interior 2h. The width dimension and height dimension of its contour are slightly greater than the width dimension and height dimension of the main part 2a, and its inner width dimension and height dimension are formed substantially equal to the inner width dimension and height dimension of the main part 2a.

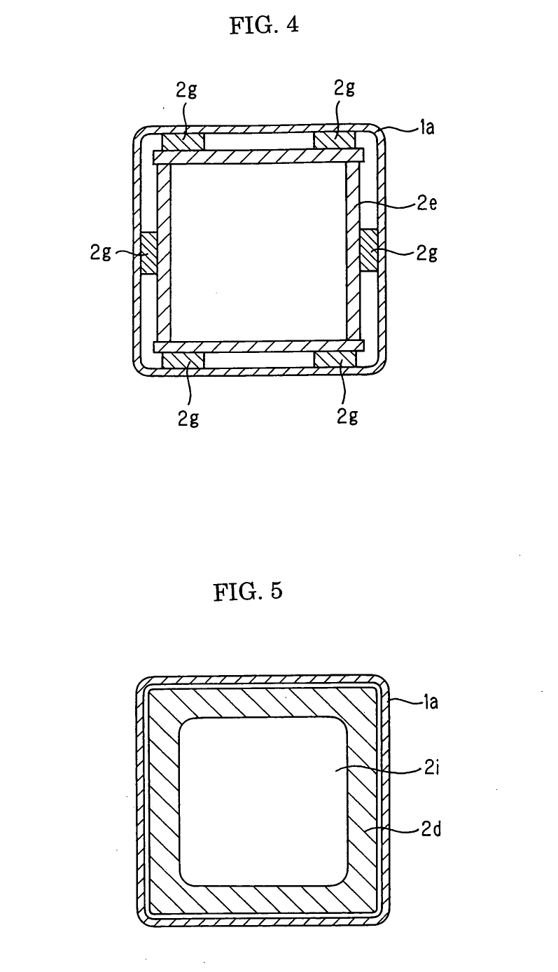

As illustrated in FIG. 1 and FIG. 4, the slide pad bracket 2e is formed in the shape of a bottomless rectangular tube having a contour width dimension and height dimension smaller than the corresponding dimensions of the main part 2a, and its overall length is formed significantly shorter than the overall length of the main part 2a and at such a length as permitting the mounting of the slide pads 2g. On the outer wall of the slide pad bracket 2e, plural (6 in the embodiment of FIG. 4) slide pads 2g are mounted at substantially equal intervals.

Like the slide pats 1g arranged on the first boom section 1, the slide pads 2g are formed in the shape of blocks, for example, with a resin material having excellent slidability such as polytetrafluoroethylene, and are fixedly secured by screws, an adhesive or the like on the outer wall of the slide pad bracket 2e. It is particularly preferred to use slide pads of the same construction as the slide pads 1g and slide pads 2g so that the sharing of common parts can be realized to improve the assembling ease of the telescopic boom device and also to reduce its manufacturing cost.

The partition 2d is formed in the shape of a plate, and as depicted in FIG. 1 and FIG. 5, is centrally provided with a rectangular hollow interior 2i. The width dimension and height dimension of its contour are slightly greater than the corresponding dimensions of the main part 2a, and the width dimension and height dimension of the hollow interior 2i are set at substantially the same as the corresponding dimensions of the main part 2a.

The boss bracket 2c and slide pad bracket 2e are integrated by welding with the main part 2a such that they become coaxial with each other via the partitions 2b, 2d. The partitions 2b, 2d are used to reduce the man-hour upon integrally securing the boss bracket 2c and slide pad bracket 2e to the main part 2a, all of which are different in cross-sectional shape.

As illustrated in FIG. 1, the telescopic boom device according to this embodiment is assembled by inserting the main part 2a and slide pad bracket 2e of the second boom section 2 in the main part 1a and slide pad bracket 1e of the first boom section 1 and then connecting unillustrated connection parts of an extension/retraction cylinder to the bosses 1f, which are arranged on the boss bracket 1c of the first boom section 1, and the bosses 2f, which are arranged on the boss bracket 2c of the second boom section 2. In the telescopic boom device according to this embodiment assembled as described above, the main parts 1a, 2a of the first and second boom sections 1,2 are caused to slide with the slide pads 1g,2g interposed therebetween when the extension/retraction cylinder is extended or retracted to cause a relative extension or retraction between the first boom section 1 and the second boom section 2. Therefore, the sliding resistance is reduced to permit a smooth extension or retraction.

In the telescopic boom device according to this embodiment, the slide pad brackets 1e, 2e having cross-sectional shapes greater or smaller than the main parts 1a, 2a are formed on the main parts 1a,2a, the slide pads 2g are mounted on the outer wall of the slide pad bracket 2e smaller in cross-sectional shape than the main part 2a, and the slide pads 1g are mounted on the inner wall of the slide pad bracket 1e greater in cross-sectional shape than the main part 1a. The slide pads 1g,2g can, therefore, be arranged without increasing the space between the boom sections 1 and 2 as opposed to the mounting of the slide pads 1g,2g between the main parts 1a and 2a of the respective boom sections 1 and 2. As a consequence, the telescopic boom device can be smoothly operated while avoiding a deterioration in the tolerance of body layout and a reduction in the strength of the boom device that would otherwise take place as a result of an enlargement of the boom main body and dimensional reductions in the cross-sectional contour of the boom device, respectively.

As the telescopic boom device according to the above-described embodiment is provided with the first boom section 1 and the second boom section 2 telescopically inserted in the first boom section 1, the above-mentioned advantageous effects can also be brought about by the two-stage telescopic boom device.

In the telescopic boom device according to this embodiment, the working ease upon fabricating each boom section can be improved by constructing the main parts 1a,1b and the boss brackets 1c,2c as discrete members. Further, the arrangement of the bosses 1f,2f by welding has been facilitated because the individual boss brackets 1c,2c are formed with such short lengths as permitting the arrangement of the bosses 1f,2f.

In the telescopic boom device according to the conventional art, it is necessary to connect the drive portion of the extension/retraction cylinder 22 to the base boom section 21a and intermediate boom section 21b. However, the boom main body 21 in the telescopic boom device according to the conventional art has the construction that the intermediate boom section 21b and fry boom section 21a are received in the base boom section 21a in the shape of a straight rectangular tube left open at an end thereof and that the extension/retraction cylinder 22 is connected to the base boom section 21a and intermediate boom section 21b at a closed-side end portion of the base boom section 21a. The telescopic boom device according to the conventional art is, therefore, poor in assembling ease. In this embodiment, on the other hand, the boss brackets 1c,2c are formed in the shape of rectangular tubes left open at both ends thereof, and hollow interiors 1h,1i are left for working. Accordingly, the connecting work of the extension/retraction cylinder to the respective bosses 1f, 2f can be facilitated. The telescopic boom device is, therefore, provided with high assembling ease.

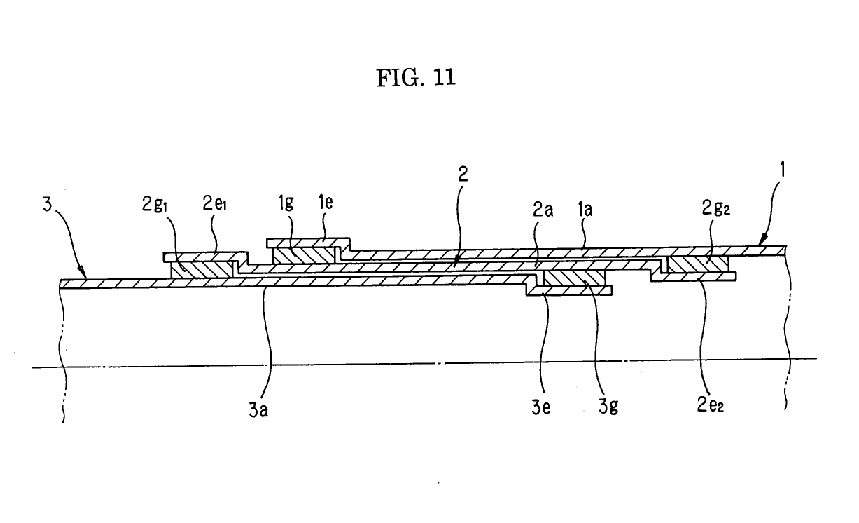

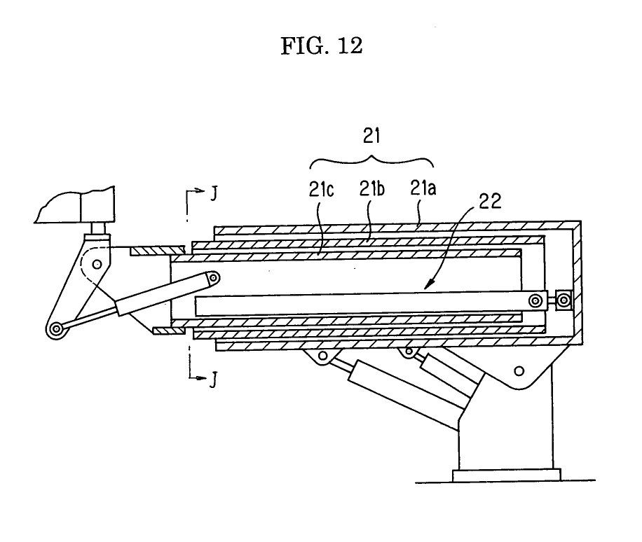

FIG. 11 is a cross-sectional view schematically illustrating a telescopic boom device according to another embodiment of the present invention. As clearly seen from FIG. 11, the telescopic boom device of this embodiment has been obtained by applying the present invention to a multi-stage telescopic boom device of three or more stages.

As depicted in FIG. 11, the telescopic boom device according to this embodiment is constructed of a first boom section 1, at least one second boom section 2 telescopically inserted in the first boom section 1 (only one second boom section is shown in the embodiment of FIG. 11), and a third boom section 3 telescopically inserted in the second boom section 2. Similarly to the above-mentioned embodiment, the first boom section 1 and second boom section 2 are provided with slide pad brackets 1e,2e₂, slide pads 1g,2g₂ are mounted on their inner walls, respectively, the third boom section 3 is provided with a slide pad bracket 3e at a position opposite to the inner wall of the second boom section 2 like the slide pad bracket 2e₂ of the second boom section 2, and slide pads 3g which undergo sliding contact with the inner wall of the second boom section 2 are arranged on the slide pad bracket 3e. Further, a slide pad bracket 2e₁ is arranged on an end portion of the second boom section 2 at a position opposite to the third boom 3. The end portion of the second boom section is on the side of a portion of the first boom section 1 where the slide pad bracket 1e is formed. Slide pads 2g₁ which undergo sliding contact with the outer wall of the third boom section 3 are mounted on the side of an inner wall of the slide pad bracket 2e₁ to reduce sliding resistance between the outer wall of the third boom section 3 and the inner wall of the second boom section 2. The slide pad bracket 2g₁ and the third boom section 3 have a similar relationship as the above-mentioned slide pad bracket 1e arranged on the first boom section 1 and the second boom section 2, and the slide pad bracket 3 and the second boom section 2 have a similar relationship as the slide pad bracket 2e₂ arranged on the second boom section 2 and the first boom section 1. The remaining elements of structure are constructed similar to the corresponding elements in the embodiment described above with reference to FIG. 1 through FIG. 10.

The construction of a multi-stage telescopic boom device of three or more stages as described above can provide a telescopic boom device that allows to arrange the slide pads 1g, 2g₁, 2g₂, 3g without resulting in dimensional enlargements of the cross-sectional contour of the boom main body. Moreover, the arrangement of the slide pads 1g, 2g₁, 2g₂, 3g does not result in dimensional enlargements so that the deterioration in the tolerance of body layout, which would otherwise take place as a result of enlargements, can be avoided. Furthermore, no dimensional reductions take place in the cross-sectional contour of the boom device so that the strength of the boom device is not reduced.

It should be borne in mind that the cross-sectional shapes and dimensions of the individual members, which make up the above-described boom devices, are not limited to the respective embodiments and can be suitably modified as needed, for example, changing the cross-sectional shapes of the boom sections into cylindrical.

What is claimed is:

1. A telescopic boom device having:
a group of tubes comprising an outer tube and at least one inner tube arranged in said outer tube such that said at least one inner tube is slidable relative to said outer tube,
an extension/retraction drive mechanism for extending or retracting said outer tube and said at least one inner tube relative to each other, and
slide members arranged within a space formed adjacent said outer tube and said at least one inner tube to smoothen relative sliding movements between said adjacent tubes, characterized in that:
a first bracket for mounting thereon slide members, which undergo sliding contact with an outer wall of said adjacent inner tube, is arranged on an inner wall of said outer tube with a clearance from an outer wall of said inner cylinder; and a second bracket for mounting thereon slide members, which undergo sliding contact with said inner wall of said outer tube, is arranged on said outer wall of said inner tube, which is located adjacent said outer tube, with a clearance from said inner wall of said outer tube.

2. A telescopic boom device according to claim 1, wherein said first bracket is arranged on a side of an end portion of said outer tube, and said second bracket is arranged on a side of an end portion of said inner tube, the latter end portion being located on a side opposite to said first bracket.

3. A telescopic boom device according to claim 1, wherein a third bracket for mounting thereon slide members, which undergo sliding contact with said inner wall of said inner tube, is arranged on a side of an outer wall of a second inner tube, said outer wall being located adjacent said inner wall of said inner tube, with a clearance from said inner wall of said inner tube; and a fourth bracket for mounting thereon slide members, which undergo sliding contact with said outer wall of said second inner tube, is arranged on a side of said inner wall of said inner tube, said inner wall being located adjacent said outer wall of said second inner tube, with a clearance from said outer wall of said second inner tube.

4. A telescopic boom device according to claim 3, wherein said first bracket is arranged on a side of an end portion of said outer tube; said second bracket is arranged on a side of an end portion of said inner tube, said end portion being located on a side opposite to said first bracket; said third bracket is arranged on a side of an end portion of said second inner tube, said end portion being located on a side of said second bracket; and said fourth bracket is arranged on a side of an end portion of said inner tube, said end portion being located on a side of said first bracket.

5. A telescopic boom device according to claim 1, wherein each bracket is arranged at a location not interfering with sliding movements of its associated tubes.

6. A telescopic boom device according to claim 1, wherein said first bracket and second bracket are provided at end portions thereof with connection parts which are connected to a drive end of said extension/retraction drive mechanism.

7. A telescopic boom device according to claim 6, wherein said connection parts are secured by welding to said end portions of said first and second brackets.

8. A telescopic boom device having at least two boom sections and an extension/retraction cylinder for telescopically extending or retracting said at least two boom sections, characterized in that:
said at least two boom sections are each constructed of a straight tubular, main part having strength and a slide pad bracket having a length shorter or longer than a length of a cross-sectional contour of said main part; said slide pad bracket the length of which is shorter than said length of said cross-sectional contour of said main part is provided on an outer wall thereof with slide pads; and said slide pad bracket the length of which is longer than said length of said cross-sectional contour of said main part is provided on an inner wall thereof with slide pads.

9. A telescopic boom device according to claim 8, wherein a first boom section and a second boom section telescopically inserted in said first boom section are provided as said booms; a slide pad bracket having a length longer than said length of said cross-sectional contour of said main part is arranged on a free end portion of said first boom section, and said slide pads are mounted on an inner wall of said slide pad bracket; and a slide pad bracket having a length shorter than said length of said cross-sectional contour of said main part is arranged on a side of a basal end of said second boom section, and said slide pads are mounted on an outer wall of said slide pad bracket.

10. A telescopic boom device according to claim 8, wherein a first boom section, at least one second boom section telescopically inserted in said first boom section and a third boom section telescopically inserted in said second boom section are provided as said booms; a slide pad bracket having a length longer than said length of said cross-sectional contour of said main part is arranged on a free end portion of said first boom section, and said slide pads are mounted on an inner wall of said slide pad bracket; a slide pad bracket having a length longer than said length of said cross-sectional contour of said main part is arranged on a free end portion of said second boom section, a slide pad bracket having a length shorter than said length of said cross-sectional contour of said main part is arranged on a basal end portion of said second boom section, and said slide pads are mounted on an inner wall of said slide pad bracket the length of which is longer than said length of said cross-sectional contour of said main part and on an outer wall of said slide pad bracket the length of which is shorter than said length of said cross-sectional contour of said main part; and a slide pad bracket having a length shorter than said length of said cross-sectional contour of said main part is arranged on a basal end portion of said third boom section, and said slide pads are mounted on an outer wall of said third boom section.

11. A telescopic boom device according to claim 8, wherein in said at least two boom sections, said two boom sections which are provided with said extension/retraction cylinder are each constructed of a straight tubular, main part, a slide pat bracket having a length shorter or longer than a length of a cross-sectional contour of said main part, and a boss bracket welded to said main part; and bosses for connecting said extension/retraction cylinder is arranged on an inner wall of said boss bracket.

12. A telescopic boom device according to claim 2, wherein each bracket is arranged at a location not interfering with sliding movements of its associated tubes.

13. A telescopic boom device according to claim 3, wherein each bracket is arranged at a location not interfering with sliding movements of its associated tubes.

14. A telescopic boom device according to claim 4, wherein each bracket is arranged at a location not interfering with sliding movements of its associated tubes.

15. A telescopic boom device according to claim 9, wherein in said at least two boom sections, said two boom sections which are provided with said extension/retraction cylinder are each constructed of a straight tubular, main part, a slide pat bracket having a length shorter or longer than a length of a cross-sectional contour of said main part, and a boss bracket welded to said main part; and bosses for connecting said extension/retraction cylinder is arranged on an inner wall of said boss bracket.

16. A telescopic boom device according to claim 10, wherein in said at least two boom sections, said two boom sections which are provided with said extension/retraction cylinder are each constructed of a straight tubular, main part, a slide pat bracket having a length shorter or longer than a length of a cross-sectional contour of said main part, and a boss bracket welded to said main part; and bosses for connecting said extension/retraction cylinder is arranged on an inner wall of said boss bracket.
